(19) United States
(12) Patent Application Publication
(10) Pub. No.: US 2009/0209155 A1
(43) Pub. Date: Aug. 20, 2009

(54) LAYERED THERMALLY-INSULATING FABRIC WITH THIN HEAT REFLECTIVE AND HEAT DISTRIBUTING CORE

(75) Inventor: Robert J. Goulet, Park City, UT (US)

Correspondence Address: Workman Nydegger;1000 Eagle Gate Tower, 60 East South Temple, Salt Lake City, UT, 84111, US

(73) Assignee: CHAPMAN THERMAL PRODUCTS, INC., Salt Lake City, UT (US)

(21) Appl. No.: 12/372,338

(22) Filed: Feb. 17, 2009

Related U.S. Application Data
(60) Provisional application No. 61/029,250, filed on Feb. 15, 2008.

(51) Int. Cl. B32B 7/00; B32B 15/14; D04H 13/00; B32B 7/08

(52) U.S. Cl. 442/234; 442/181; 442/292; 442/301; 442/326; 442/327; 442/378; 442/394; 442/414; 156/92

(57) ABSTRACT

A composite fire-resistant, heat-diffusing, and heat-reflective article. The article includes at least two layers of a fire-retardant and heat-resistant fabric with a heat diffusing and/or heat-reflective core disposed between the fabric layers. The core may include at least one layer of a thin metal foil (e.g., thin aluminum foil). The composite fire-resistant, heat-diffusing, and heat-reflective article provides durability, fire resistance, and the ability to withstand high heat exposure on one face for an extended period of time without transferring significant heat to the opposite face. Combining fire-retardant fabrics with a heat diffusing and/or heat-reflective core achieves a true synergy by offering greater fire and heat protection to persons and structures than either component can offer alone.

### CROSS-REFERENCE TO RELATED APPLICATION

This application claims priority to U.S. Provisional Patent Application Ser. No. 61/029,250 filed Feb. 15, 2008 to Goulet entitled “LAYERED THERMALLY-INSULATING FABRIC WITH THIN METAL HEAT REFLECTIVE AND HEAT DISTRIBUTING CORE,” the entirety of which is incorporated herein by specific reference.

### BACKGROUND OF THE INVENTION

1. The Field of the Invention

The present invention is in the field of fire-retardant and heat-resistant composite structures.

2. The Relevant Technology

Fire-retardant articles are widely used to protect persons and structures. For example, fire-retardant clothing is used to protect persons who are exposed to fire, particularly suddenly occurring and fast burning conflagrations. These include persons in diverse fields, such as race car drivers, military personnel, and fire fighters, each of which may be exposed to deadly fires and extremely dangerous incendiary conditions. For such persons, the primary line of defense against severe burns and even death is the protective clothing worn over some or all of the body. In the case of structures, fire resistant articles may be used to protect small areas form the heat associated with welding or plumbing repairs. There is also interest is the development of articles that could be used to cover an entire structure to protect it from fire damage such as from a forest fire.

Even though fire-retardant clothing and articles presently exist, such clothing and articles do not always reliably offset the risk of severe burns, death, or total destruction if the person or structure is exposed to extreme heat for an extended period of time. This is due to the fact that while most clothing and articles are designed to prevent the person or structure from catching fire, the clothing and articles still permit significant amounts of heat to penetrate the garment or article.

A wide variety of different fibers and fibrous blends have been used in the manufacture of fire and heat-resistant fabrics. Fire retardance, heat resistance, strength and abrasion resistance all play an important role in the selection of materials used to make such fabrics. However, it is difficult to satisfy all of the foregoing desired properties. There is often a compromise between fire retardance and heat resistance, on the one hand, and strength and abrasion resistance, on the other.

Conventional fire-retardant fabrics on the market typically rate very high in one, or perhaps two, of the foregoing desired properties. One example is a proprietary fabric m-aramid fabric sold by DuPont, which rates high in strength and abrasion resistance at room temperature but only provides protection against high temperatures and flame for a relatively short period of time. When exposed to direct flame, the leading m-aramid “fire-retardant” fabric begins to shrink and char in as little as 3 seconds, and the degradation of the fabric increases as the duration of exposure increases. Ironically, it is the tendency of m-aramid fabrics to char and shrink that is purported to protect the wearer's skin from heat and flame. M-aramid fabrics may protect the wearer from burns for several seconds, but becomes essentially worthless as a protective shield after it has begun to char, shrink and decompose. Once this occurs, large holes can open up through which flame and heat can pass, thus burning, or even charring, the naked skin of the person wearing the fabric. Fabrics based on p-aramid are also strong and resist abrasion at room temperature but also char and shrink when exposed to flame or high temperature.

Flammable fabrics such as cotton, polyester, rayon, and nylon can be treated with a fire-retardant finish to enhance fire retardance. While this may temporarily increase the flame retardant properties of such fabrics, typical fire-retardant finishes are not permanent. Exposure of the treated fabric to UV radiation (e.g., sun light) as well as routine laundering of the fabric can greatly reduce the fire-retardant properties of the fabric. The user may then have a false sense of security, thus unknowingly exposing himself to increased risk of burns. There may be no objective way to determine, short of being caught in a fiery conflagration, whether a treated garment still possesses sufficient fire retardance to offset the risks to which the wearer may be exposed.

More recently, a range of highly fire-retardant and heat-resistant yarns and fabrics comprised of oxidized polyacrylonitrile fibers blended with one or more strengthening fibers were developed. Yarns and fabrics made exclusively from oxidized polyacrylonitrile fibers lack adequate strength for use in many applications. Blending oxidized polyacrylonitrile fibers with one or more types of strengthening fibers yields yarns and fabrics having increased strength and flexibility. U.S. Pat. Nos. 6,287,686 and 6,358,608 to Huang et al. disclose a range of yarns and fabrics that preferably include about 85.5-99.9% by weight oxidized polyacrylonitrile fibers and about 0.1-14.5% by weight of one or more strengthening fibers. U.S. Pat. No. 4,865,906 to Smith, Jr. includes about 25-85% oxidized polyacrylonitrile fibers combined with at least two types of strengthening fibers. For purposes of teaching fire-retardant and heat-resistant yarns, fabrics and articles of manufacture, the foregoing patents are incorporated herein by reference.

Highly flame retardant and heat-resistant fabrics made according to the Huang et al. patents are sold under the name CARBONX by Chapman Thermal Products, Inc., located in Salt lake City, Utah. Such fabrics are able to resist burning or charring even when exposed to a direct flame. Fabrics made according to the Huang et al. and Smith, Jr. patents are not only superior to m-aramid fabrics as far as providing fire retardance and heat resistance, they are softer, have higher breathability, and are better at absorbing sweat and moisture. CARBONX feels much like an ordinary fabric made from natural or natural feeling synthetic fibers. M-aramid fabric, in contrast, feels more like wearing a plastic sheet than a fabric since it does not breathe well, nor does it wick sweat and moisture but sheds it readily.

Some applications may require a level of tensile strength, abrasion resistance, and durability not provided by conventional fire-retardant fabrics. One way to improve such features is to incorporate a metallic filament, such as is disclosed in U.S. Pat. No. 6,800,367 and U.S. Pat. No. 7,087,300, both to Hanyon et al., the disclosures of which are incorporated by reference. Including a metal filament also increases the cut resistance of the fabric.

### BRIEF SUMMARY OF THE INVENTION

The present invention encompasses novel composite fire-resistant, heat diffusing, and heat-reflective articles, methods of manufacturing such articles, and methods of use. The novel composite fire-resistant, heat diffusing, and heat-reflective articles of the present invention combine durability, fire resistance, and the ability to withstand high heat exposure on one face for an extended period of time without transferring significant heat to the opposite face. The articles include at least two layers of a fire-retardant and heat-resistant fabric with a heat diffusing and/or heat-reflective core disposed between the fabric layers. Combining fire-retardant fabrics with a heat diffusing and/or heat-reflective core achieves a true synergy that offers greater fire and heat protection to persons and structures than either component can offer alone.

In one embodiment, a composite fire-resistant and heat-blocking article is disclosed. An exemplary composite fire-resistant and heat-blocking article includes at least two layers of a fire-retardant and heat-resistant fabric forming a first face and a second opposite face, and a core material disposed between said fabric layers including at least one layer of a heat-diffusing and/or heat-reflective material.

In one embodiment, a composite fire-resistant and heat-blocking article is characterized by the ability to withstand direct exposure to a flame or another heat source having a temperature of at least about 1500° C. on the first face for at least 1 minute without transferring significant heat to the second opposite face. The composite fire-resistant and heat-blocking articles described herein are able to protect a wood surface from charring by a flame having a temperature of at least about 1500° C. for at least one minute, whereas a fire-retardant and heat-resistant fabric having no heat-diffusing and/or heat-reflective core material only protected the wood surface for about 10 seconds.

Without being tied to one theory, it is believed that the heat-diffusing and/or heat-reflective core material acts to diffuse heat away from the site of concentrated heat application on the first face of the article, thus preventing the heat from traveling through the article to the opposite face. In a complementary theory, it is believed that the core material can prevent hot gases from traveling through the article such that heat that is applied to one face of the article is not carried through to the opposite face but is deflected or diffused.

Suitable examples of heat-diffusing and/or heat-reflective core materials that can be used in the article include, but are not limited to, aluminum foils, metalized polyimide films, or metalized fire-resistant fabrics, and combinations thereof.

In one embodiment, the heat-diffusing and/or heat-reflective core material can include an aluminum foil having a thickness between about 0.004 mm and about 0.15 mm. Preferably, the aluminum foil has a thickness between about 0.005 mm and about 0.05 mm and, more preferably, the aluminum foil has a thickness between about 0.006 mm and about 0.02 mm.

In one embodiment, the composite fire-resistant and heat-blocking article recited herein includes between one and ten or between one and twenty layers of heat-distributing and/or reflective core material. Preferably, the composite fire-resistant and heat-blocking article recited herein includes between two and six layers of heat-distributing and/or reflective core material or, more preferably, the composite fire-resistant and heat-blocking article recited herein includes three or four layers of heat-distributing and/or reflective core material.

Suitable examples of fire-retardant and heat-resistant fabrics that can be used in the composite fire-resistant and heat-blocking article recited herein include oxidized polyacrylonitrile (O-PAN), reinforced O-PAN, p-aramid, m-aramid, melamine, polybenzimidazole (PBI), polyimides, polyamideimides, partially oxidized polyacrylonitriles, novoloids, poly(p-phenylene benzobisoxazole) (PBO), poly(p-phenylene benzothiazoles) (PBT); polyphenylene sulfide (PPS), flame retardant viscose rayons, polyetheretherketones (PEEK), polyketones (PEK), polyetherimides (PEI), chloropolymeric fibers, modacrylics, fluoropolymeric fibers, and combinations thereof.

In one embodiment, the composite fire-resistant and heat-blocking article described herein can further include an insulative heat barrier material disposed amongst the at least one layer of a heat-diffusing and/or heat-reflective material between the first and second outer layers of the fire-retardant and heat-resistant fabric. In one embodiment, the insulative heat barrier material can be selected from the group consisting of felted fabrics, woven fabrics, spun refractory fibers, and combinations thereof.

In an alternative embodiment, a composite fire-resistant and heat absorbing article includes at least two layers of a fire-retardant and heat-resistant fabric joined together so as to form at least one cavity between the at least two layers, and a heat-distributing and/or heat reflective core material disposed within the at least one cavity.

Suitable examples of fire-retardant and heat-resistant fabrics that can be included in the article described herein include fibers having a limiting oxygen index (LOI) of at least 50 such that the at least two layers of fire-retardant and heat-resistant fabric will not support combustion when exposed to a flame or another heat source.

In one embodiment, the composite fire-resistant and heat-blocking article can further include at least one moldable element such that the article can be stably molded to fit around a shaped surface. Suitable examples moldable elements include, but are not limited to, a flexible metal wire disposed around the periphery of the article.

In one embodiment, a method of making a composite fire-resistant and heat-blocking article includes (1) providing at least two layers of a fire-retardant and heat-resistant fabric, (2) providing at least one layer of a heat-diffusing and/or heat-reflective material, (3) arranging the at least two layers of fabric and the at least one layer of heat-diffusing and/or heat-reflective material such that the fire-retardant and heat-resistant fabric layers form first and second outer layers and the heat-diffusing and/or heat-reflective material is disposed between the first and second outer layers of fabric, and (4) joining the fabric and metallic or metalized layers together to form the composite fire-resistant and heat-blocking article.

In one embodiment, the joining can include techniques such as sewing, needle punching, gluing, riveting, and the like.

In one embodiment, a method of making a composite fire-resistant and heat-blocking article can further include (1) providing an insulative heat barrier material selected from the group consisting of felted fabrics, woven fabrics, spun refractory fibers, and combinations thereof, and (2) disposing the heat-diffusing and/or heat-reflective material between the first and second outer layers of the fire-retardant and heat-resistant fabric.

The articles of the present invention can be incorporated into and/or comprise a wide variety of articles. Examples include, but are not limited to, clothing, jump suits, gloves, socks, pot holders, welding bibs, fire blankets, floor boards, padding, protective head gear, linings, cargo holds, mattress insulation, drapes, insulating fire walls, and the like.

As such, one embodiment of the present invention includes a method for using a composite fire-resistant and heat absorbing article to protect a person from extreme heat or burning. Articles manufactured according to the present invention are able to withstand direct exposure to a flame or heat source on one face for at least one minute without transferring significant heat to a second opposite face. A method for protecting a person or structure using a composite fire-resistant and heat absorbing article manufactured according to the present invention includes a step of draping the composite fire-resistant and heat absorbing article over an area that might be subject to burning. For example, articles of the present invention can be used to protect firefighters, welders, race car drivers, and other persons who may be exposed to extreme heat or flame sources for an extended period of time.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A illustrates an exemplary composite fire-resistant and heat-blocking article according to one embodiment of the present invention;

FIG. 1B illustrates the composite fire-resistant and heat-blocking article of FIG. 1A in which the layers of the composite article are separated to show first and second outer layers of a fire-retardant and heat-resistant fabric and a heat-reflective and/or heat-diffusing core;

FIG. 2 illustrates a cross-sectional view of the composite fire-resistant and heat-blocking article of FIGS. 1A and 1B;

FIG. 3 illustrates a cross-sectional view of an alternate embodiment of a composite fire-resistant and heat-blocking article that includes outer fabric layers and multiple heat-reflective and/or heat-diffusing core layers;

FIG. 4 illustrates a cross-sectional view of another alternate embodiment of a composite fire-resistant and heat-blocking article that includes multiple fabric layers and multiple heat-reflective and/or heat-diffusing core layers; and

FIG. 5 illustrates a cross-sectional view of yet another alternate embodiment of a composite fire-resistant and heat-blocking article that includes multiple fabric layers, multiple heat-reflective and/or heat-diffusing core layers, and a non-woven fabric layer that includes a reinforcing scrim layer.

### DETAILED DESCRIPTION OF THE PREFERRED EMBODIMENTS

### I. Introduction and Definitions

The present invention encompasses novel composite fire-resistant, heat diffusing, and heat-reflective articles, methods of manufacturing such articles, and methods of use. The novel composite fire-resistant, heat diffusing, and heat-reflective articles of the present invention combine durability, fire resistance, and the ability to withstand high heat exposure on one face for an extended period of time without transferring significant heat to the opposite face. The articles include at least two layers of a fire-retardant and heat-resistant fabric with a heat diffusing and/or heat-reflective core disposed between the fabric layers. Combining fire-retardant fabrics with a heat diffusing and/or heat-reflective core achieves a true synergy by offering greater fire and heat protection to persons and structures than either component can offer alone.

In general, heat degrades fibers and fabrics at different rates depending on fiber chemistry, the level of oxygen in the surrounding atmosphere of the fire, and the intensity of fire and heat. There are a number of different tests used to determine a fabric's flame retardance and heat resistance rating, including the Limiting Oxygen Index, continuous operating temperature, and Thermal Protective Performance.

The term “Limiting Oxygen Index” (or “LOI”) is defined as the minimum concentration of oxygen necessary to support combustion of a particular material. LOI is measured by passing a mixture of O₂ and N₂ over a burning specimen, and reducing the O₂ concentration until combustion is no longer supported. Hence, higher LOI values represent better flame retardancy. LOI is primarily a measurement of flame retardancy rather than temperature resistance. Temperature resistance is typically measured as the “continuous operating temperature.”

The term “continuous operating temperature” measures the maximum temperature, or temperature range, at which a particular fabric will maintain its strength and integrity over time when exposed to constant heat of a given temperature or range. For instance, a fabric that has a continuous operating temperature of 400° F. (i.e., 190° C.) can be exposed to temperatures of up to 400° F. for prolonged periods of time without significant degradation of fiber strength, fabric integrity, and protection of the user. In some cases, a fabric having a continuous operating temperature of 400° F. may be exposed to brief periods of heat at higher temperatures without significant degradation. The presently accepted standard for continuous operating temperature in the auto racing industry rates fabrics as being “flame retardant” if they have a continuous operating temperature of between 375° F. to 600° F. (i.e., 175° C. to 300° C.).

The term “fire-retardant” refers to a fabric, felt, yarn or strand that is self extinguishing. The term “nonflammable” refers to a fabric, felt, yarn or strand that will not burn.

The term “Thermal Protective Performance” (or “TPP”) relates to a fabric's ability to provide continuous and reliable protection to a person's skin beneath a fabric when the fabric is exposed to a direct flame or radiant heat. The TPP measurement, which is derived from a complex mathematical formula, is often converted into an SFI rating, which is an approximation of the time it takes before a standard quantity of heat causes a second degree burn to occur.

The term “SFI Rating” is a measurement of the length of time it takes for someone wearing a specific fabric to suffer a second degree burn when the fabric is exposed to a standard temperature. The SFI Rating is printed on a driver's suit. The SFI Rating is not only dependent on the number of fabric layers in the garment, but also on the LOI, continuous operating temperature and TPP of the fabric or fabrics from which a garment is manufactured. The standard SFI Ratings are as follows:

| SFI Rating | Time to Second Degree Burn |
|---|---|
| 3.2 A/1 | 3 Seconds |
| 3.2 A/3 | 7 Seconds |
| 3.2 A/5 | 10 Seconds |
| 3.2 A/10 | 19 Seconds |
| 3.2 A/15 | 30 Seconds |
| 3.2 A/20 | 40 Seconds |

A secondary test for flame retardance is the after-flame test, which measures the length of time it takes for a flame retardant fabric to self extinguish after a direct flame that envelopes the fabric is removed. The term “after-flame time” is the measurement of the time it takes for a fabric to self extinguish. According to SFI standards, a fabric must self extinguish in 2.0 seconds or less in order to pass and be certifiably “flame retardant”.

The term “reinforced oxidized polyacrylonitrile” refers to O-PAN fibers, yarns, and fabrics that are manufactured from O-PAN that is reinforced with one or more strengthening fibers.

The term “tensile strength” refers to the maximum amount of stress that can be applied to a material before rupture or failure. The “tear strength” is the amount of force required to tear a fabric. In general, the tensile strength of a fabric relates to how easily the fabric will tear or rip. The tensile strength may also relate to the ability of the fabric to avoid becoming permanently stretched or deformed. The tensile and tear strengths of a fabric should be high enough so as to prevent ripping, tearing, or permanent deformation of the garment in a manner that would significantly compromise the intended level of thermal protection of the garment.

The term “abrasion resistance” refers to the tendency of a fabric to resist fraying and thinning during normal wear. Although related to tensile strength, abrasion resistance also relates to other measurements of yarn strength, such as shear strength and modulus of elasticity, as well as the tightness and type of the weave or knit.

The term “cut resistance” refers to the tendency of yarn or fabrics to resist being severed when exposed to a shearing force.

The terms “fiber” and “fibers”, as used in the specification and appended claims, refers to any slender, elongated structure that can be carded or otherwise formed into a thread. Fibers are characterized as being no longer than 25 mm. Examples include “staple fibers”, a term that is well-known in the textile art. The term “fiber” differs from the term “filament”, which is defined separately below and which comprises a different component of the inventive yarns.

The term “thread”, as used in the specification and appended claims, shall refer to continuous or discontinuous elongated strands formed by carding or otherwise joining together one or more different kinds of fibers. The term “thread” differs from the term “filament”, which is defined separately below and which comprises a different component of the inventive yarns.

The term “filament”, as used in the specification and appended claims, shall refer to a single, continuous or discontinuous elongated strand formed from one or more metals, ceramics, polymers or other materials and that has no discrete sub-structures (such as individual fibers that make up a “thread” as defined above). “Filaments” can be formed by extrusion, molding, melt-spinning, film cutting, or other known filament-forming processes. A “filament” differs from a “thread” in that a filament is, in essence, one continuous fiber or strand rather than a plurality of fibers that have been carded or otherwise joined together to form a thread. “Filaments” are characterized as strands that are longer than 25 mm, and may be as long as the entire length of yarn (i.e., a monofilament).

“Threads” and “filaments” are both examples of “strands”.

The term “yarn”, as used in the specification and appended claims, refers to a structure comprising a plurality of strands. The inventive yarns according to the invention comprise at least one high-strength filament and at least one heat-resistant and flame retardant strand that have been twisted, spun or otherwise joined together to form the yarn. This allows each component strand to impart its unique properties along the entire length of the yarn.

The term “fabric”, as used in the specification and appended claims, shall refer to one or more different types of yarns that have been woven, knitted, or otherwise assembled into a desired protective layer.

When measuring the yarn, both volume and weight measurement may be applicable. Generally, volumetric measurements will typically be used when measuring the concentrations of the various components of the entire yarn, including threads and filaments, whereas weight measurements will typically be used when measuring the concentrations of one or more staple fibers within the thread or strand portion of the yarn.

### II. Composite Fire-Resistant and Heat-Blocking Articles

In one embodiment, a composite fire-resistant and heat-blocking article is disclosed. An exemplary composite fire-resistant and heat-blocking article includes at least two layers of a fire-retardant and heat-resistant fabric forming a first face and a second opposite face, and a core material disposed between said fabric layers including at least one layer of a heat-diffusing and/or heat-reflective material.

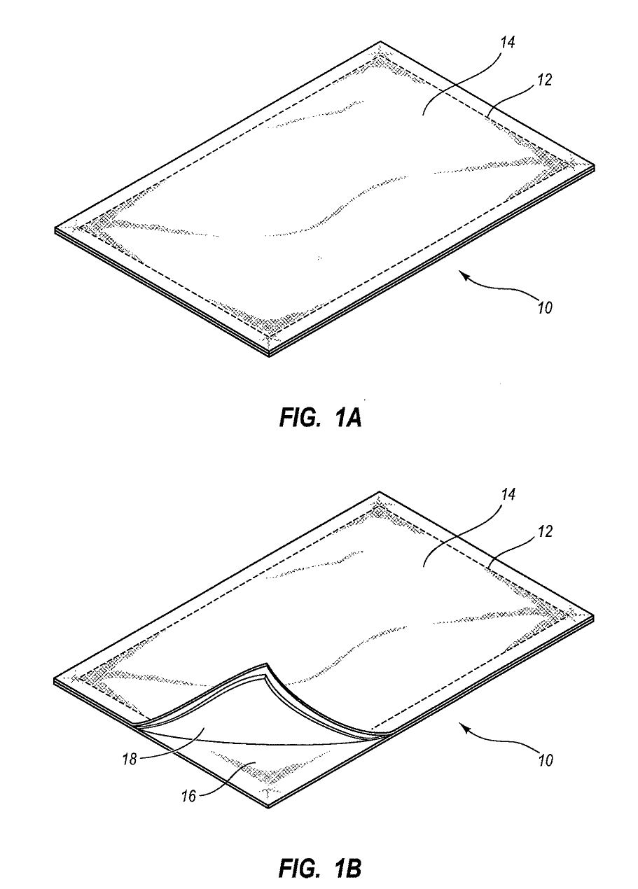

FIGS. 1A and 1B illustrate an exemplary composite fire-resistant and heat-blocking article 10 according to one embodiment of the present invention. FIG. 1A is a plan view of exemplary composite fire-resistant and heat-blocking article 10, and FIG. 1B shows the article 10 of FIG. 1A in which the layers of the composite fire-resistant and heat-blocking article 10 are separated to show the interior structure. The composite fire-resistant and heat-blocking article 10 depicted in FIGS. 1A and 1B includes a first layer of fire-retardant and heat-resistant fabric 14, a second layer of fire-retardant and heat-resistant fabric 16, and a core layer consisting of a heat-diffusing and/or heat-reflective material 18 disposed between fabric layers 14 and 16.

In the embodiment depicted in FIGS. 1A and 1B, the various layers of article 10 are joined by stitching 12 around the edge of the article 10. One will appreciate, however, that other methods known in the art can be used to couple the various layers of the article 10 including, but not limited to, needle punching, gluing, riveting, and the like.

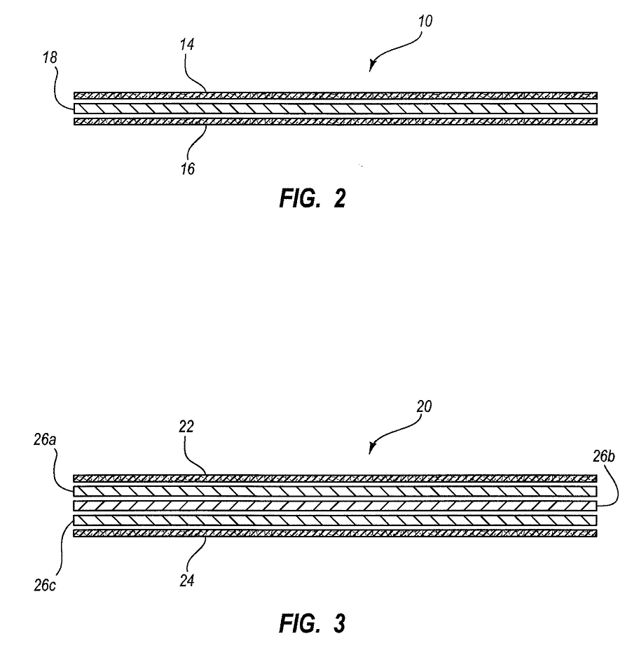

FIG. 2 is a cross-sectional view of the composite fire-resistant and heat-blocking article 10 depicted in FIGS. 1A and 1B. The composite article 10 consists of first and second outer layers of fire-retardant and heat-resistant fabric 14 and 16 and a heat-diffusing and/or heat-reflective core material 18 disposed between the outer fabric layers 14 and 16. The composite fire-resistant and heat-blocking article illustrated in FIG. 2 is characterized by the ability to withstand direct exposure to a flame or another heat source having a temperature of at least about 1500° C. on the first face for at least 1 minute without transferring significant heat to the second opposite face.

Fire-retardant and heat-resistant fabric layers 14 and 16 provide a durable, preferably abrasion resistant, fire-resistant and heat-resistant outer layer for the article 10. The fire-retardant and heat-resistant fabric is chosen from the group consisting of oxidized polyacrylonitrile (O-PAN), reinforced O-PAN, p-aramid (e.g., Kevlar), m-aramid (e.g., Nomex), melamine (e.g., BASOFIL), polybenzimidazole (PBI), polyimides (e.g., KAPTON), polyamideimides (e.g., KERMEL), partially oxidized polyacrylonitriles (e.g., FORTAFIL OPF), novoloids (e.g., phenol-formaldehyde novolac), poly(p-phenylene benzobisoxazole) (PBO), poly(p-phenylene benzothiazoles) (PBT); polyphenylene sulfide (PPS), flame retardant viscose rayons, polyetheretherketones (PEEK), polyketones (PEK), polyetherimides (PEI), chloropolymeric fibers (e.g., FIBRAVYL L9F), modacrylics (e.g., PROTEX), fluoropolymeric fibers (e.g., TEFLON TFE), and combinations thereof. In a preferred embodiment, the outer fabric layers 14 and 16 are made from reinforced oxidized polyacrylonitrile, which is sold under the trade name CARBONX.

Reinforced oxidized polyacrylonitrile (i.e., CARBONX) is composed of oxidized polyacrylonitrile (O-PAN) fibers and at least one strengthening and/or reinforcing fiber. O-PAN fibers have tremendous fire-retardant and heat-resistant properties, but they lack tensile strength. Strengthening and/or reinforcing fibers or filaments may be included with O-PAN in order to increase the tensile strength of the resultant fibers. Fibers, yarns, and fabrics made of reinforced O-PAN are disclosed in a number of United States patents, including U.S. Pat. Nos. 6,358,608, 6,827,686, 6,800,367, 7,087,300, and U.S. patent application Ser. No. 11/691,248, all of which are incorporated in their entirety herein by reference.

The O-PAN and the reinforcing fibers and/or strengthening filaments are blended together so as to form a fibrous blend having increased strength and abrasion resistance compared to a yarn, fabric, or felt consisting exclusively of oxidized polyacrylonitrile fibers. Preferably, O-PAN is included in an amount in an range from about 50 percent to about 99.9 percent by weight of the fiber blend with the remainder being made up of reinforcing fibers and/or strengthening filaments. More preferably, the fibrous blend includes O-PAN fibers in a range from about 75 percent to about 99.5 percent by weight of the fibrous blend, with the remainder consisting of reinforcing fibers and/or strengthening filaments. Even more preferably, the fibrous blend includes O-PAN fibers in a range from about 85 percent to about 99 percent by weight of the fibrous blend, with the remainder consisting of reinforcing fibers and/or strengthening filaments. Most preferably, the fibrous blend includes O-PAN fibers in a range from about 90 percent to about 97 percent by weight of the fibrous blend, with the remainder consisting of reinforcing fibers and/or strengthening filaments.

In one embodiment, the strengthening fibers include at least one of polybenzimidazole, polyphenylene-2,6-benzobisoxazole, modacrilic, p-aramid, m-aramid, a polyvinyl halide, wool, a fire resistant polyester, a fire resistant nylon, a fire resistant rayon, cotton, or melamine. In another embodiment, the strengthening filaments include at least one of metallic filaments, high strength ceramic filaments, high strength polymer filaments, and combinations thereof.

Reinforced O-PAN fibers may be assembled into woven fabric or non-woven felt materials. In one embodiment, at least one of the fabric layers may include a non-woven material. In another embodiment, at least one of the fabric layers may include a woven material.

In one embodiment of the present invention, suitable examples of fire-retardant and heat-resistant fabrics that can be included in the article described herein include fibers having a limiting oxygen index (LOI) of at least 50 such that the at least two layers of fire-retardant and heat-resistant fabric will not support combustion when exposed to a flame or another heat source. As defined above, LOI refers to the minimum concentration of oxygen necessary to support combustion of a particular material. A fire-retardant and heat-resistant fabric having an LOI of 50 will not support combustion at an oxygen concentration lower than 50%. The Earth's atmosphere includes about 21% oxygen and a mix of other gases. This means that a fire-retardant and heat-resistant fabric having an LOI of 50 will generally not support combustion in the Earth's atmosphere.

The core 18 enhances the fire-resistant and heat-blocking characteristics of the article 10 in several potential ways. For example, core 18 can block the passage of hot gases through the article 10, core 18 can reflect heat away from the article 10, and core 18 can increase the time required to burn through the article 10 by diffusing heat away from the site where heat is applied.

The core material 18 is selected from the group consisting of aluminum foil, metalized polyimide film, metalized fire-resistant fabric, and combinations thereof. In a preferred embodiment, the core material 18 is aluminum foil. More preferably, the core material 18 is an industrial grade aluminum foil.

Industrial grade aluminum foil differs from the common kitchen variety in that the industrial grade is typically a purer grade of aluminum, it is uncoated, and it is available in a wider range of thicknesses. Preferably, the aluminum foil has a thickness in a range between about 0.004 mm and about 0.15 mm. More preferably, the aluminum foil has a thickness in a range between about 0.005 mm and about 0.05 mm. Most preferably, the aluminum foil has a thickness in a range between about 0.006 mm and about 0.02 mm.

The inventor has also advantageously discovered that thinner aluminum foils provide excellent fire and heat protection while also suppressing the crinkle sound that thicker foils can produce. Moreover, thin foils are very inexpensive. For example, an industrial-grade aluminum foil that is about 0.006 mm thick costs about $0.03 per square yard.

FIG. 3 illustrates a cross-sectional view of an embodiment of a composite fire-resistant and heat-blocking article 20 manufactured according to one embodiment of the present invention. The article 20 consists of two outer layers fire-resistant fabric 22 and 24 and multiple metallic and/or metalized core layers 26a-26c.

While a core that includes a single layer of heat-diffusing and/or heat-reflective core material offers excellent protection against heat and fire, the inventor has found that multiple thin layers of heat-diffusing and/or heat-reflective core material are superior to one thick layer. Without being tied to one theory, this can be explained at least in part by the fact that the individual layers do not burn through simultaneously and there is a thin layer of trapped air between the multiple layers that provides some insulation. Preferably, the core is made up of between one (1) layer and ten (10) layers or between one (1) layer and twenty (20) layers of heat-distributing and/or heat-reflective material. More preferably, the core is made up of between two (2) and six (6) layers of heat-distributing and/or heat-reflective material. FIG. 3 illustrates a preferred embodiment in which the core 26a-26c is made up of three (3) layers of heat-distributing and/or heat-reflective material.

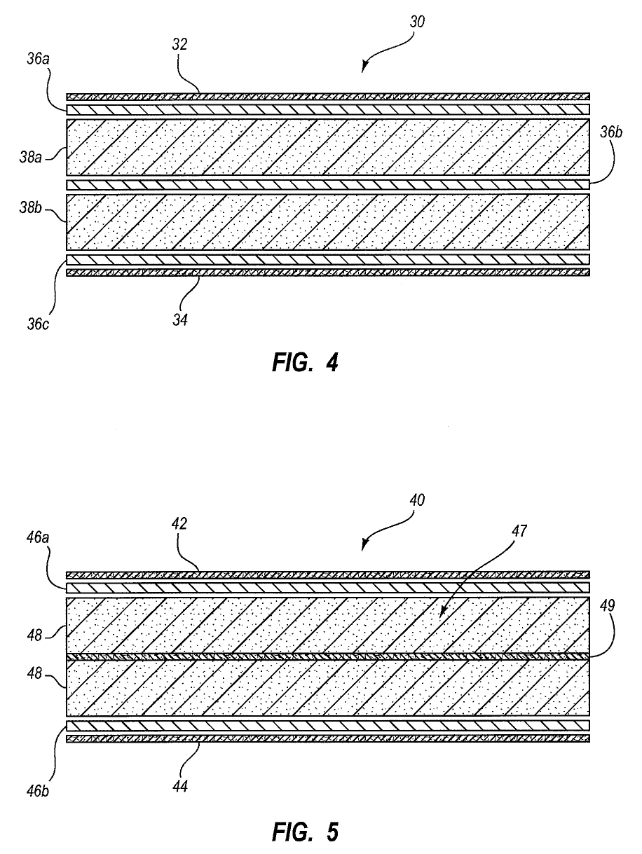

Articles manufactured according to the present invention can take on a number of additional permutations. For example, FIG. 4 illustrates a cross-sectional view of an embodiment of a composite fire-resistant and heat-blocking article 30 that consists of two outer layers of woven fire-retardant and heat-resistant fabric 32 and 34, three heat-diffusing and/or heat-reflective core layers 36a-36c, and two layers of an insulative heat barrier material 38a-38b. In one embodiment, the insulative heat barrier material can be selected from the group consisting of felted fabrics (e.g., wool felt), woven fabrics (e.g., wool), spun refractory fibers (e.g., spun kaolin wool, an example of which is sold by Thermal Ceramics Co. under the brand name KAOWOOL-RT), aerogel, insulating fire clay, pumice and combinations thereof. Combining insulative and heat distributing materials provides a synergistic effect whereby the composite article performs at a level that is greater than the added effects of each layer individually. This increases the effectiveness of the insulative material and increases burn through time.

FIG. 5 illustrates a cross-sectional view of another embodiment of a composite fire-resistant and heat-blocking article 40 that consists of two outer layers of woven fire-retardant and heat-resistant fabric 42 and 44, two heat-reflective and/or heat-diffusing layers 46a-46b, and a non-woven center 47 that consists of two layers of non-woven felt-like fire-resistant material 48 that are joined together with a reinforcing scrim material 49 in between the felt layers 48. The felt 48 may be joined to the scrim layer 49 by sewing or needle punching, for example. The scrim material 49 adds addition tensile strength to the article 40.

### EXAMPLES

The fire-resistant and heat-resistant properties of the articles of the present invention were demonstrated by determining the amount of time required to char wood with a torch having a temperature of about 1500° C.

In the experiment, articles of the present invention were attached to a wood surface, a flame from the approximately 1500° C. torch was brought into contact with the article, and the time required to burn the underlying wood was determined. For the sake of comparison, controls consisting of unprotected wood and wood protected by two layers of fire-resistant CARBONX fabric were used.

In the experiment, the unprotected wood charred almost instantly while the two, layers of CARBONX protected the wood from charring for about 10 seconds. In contrast, an article consisting of two layers of CARBONX with a heat-reflective and/or heat-diffusing core consisting of a single layer of aluminum foil protected the wood surface from charring for at least one minute. The time required to char the underlying wood surface could be increased by increasing the number of foil layers in the heat-diffusing and/or heat-reflective core. These data represent a significant increase in the level of fire protection as compared to CARBONX alone.

While the foregoing experiments used the ability to protect wood from charring as a model for fire and heat protection, it should be understood that the results also demonstrate that the composite fire-resistant and heat-blocking articles described herein can also protect a person's skin. For instance, the articles described herein, which can be incorporated into protective garments, can protect a wearer for greater periods of time than heat-resistant or fire-protective articles currently available on the market. Such a difference would provide a wearer with considerable additional protection in the case of exposure to extreme heat, such as from a conflagration.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A composite fire-resistant and heat-blocking article, comprising:
at least two outer layers of a fire-retardant and heat-resistant fabric forming a first face and a second opposite face; and
a core material disposed between said outer layers of fabric that includes at least one layer of a heat-diffusing and/or heat-reflective material.

2. A composite fire-resistant and heat-blocking article as recited in claim 1, wherein the article is able to withstand direct exposure to a flame or another heat source having a temperature of at least about 1500° C. on the first face for at least 1 minute without transferring significant heat to the second opposite face.

3. A composite fire-resistant and heat-blocking article as recited in claim 1, the core material being selected from the group consisting of aluminum foil, metalized polyimide film, metalized fire-resistant fabric, and combinations thereof.

4. A composite fire-resistant and heat-blocking article as recited in claim 1, the core material comprising aluminum foil having a thickness between about 0.004 mm and about 0.15 mm.

5. A composite fire-resistant and heat-blocking article as recited in claim 1, the core material comprising aluminum foil having a thickness between about 0.006 mm and about 0.02 mm.

6. A composite fire-resistant and heat-blocking article as recited in claim 1, the core material including between one and ten layers of heat-distributing and/or reflective material.

7. A composite fire-resistant and heat-blocking article as recited in claim 1, the core material including between two and six layers of heat-distributing and/or reflective material.

8. A composite fire-resistant article as recited in claim 1, wherein the fire-retardant and heat-resistant fabric is selected from the group consisting of oxidized polyacrylonitrile (O-PAN), reinforced O-PAN, p-aramid, m-aramid, melamine, polybenzimidazole (PBI), polyimides, polyamideimides, partially oxidized polyacrylonitriles, novoloids, poly(p-phenylene benzobisoxazole) (PBO), poly(p-phenylene benzothiazoles) (PBT); polyphenylene sulfide (PPS), flame retardant viscose rayons, polyetheretherketones (PEEK), polyketones (PEK), polyetherimides (PEI), chloropolymeric fibers, modacrylics, fluoropolymeric fibers, and combinations thereof.

9. A composite fire-resistant and heat-blocking article as recited in claim 1, the core material further including an insulative heat barrier material disposed among the at least one layer of a heat-diffusing and/or heat-reflective material between the outer layers of fire-retardant and heat-resistant fabric, the insulative heat barrier material being selected from the group consisting of felted fabrics, woven fabrics, spun refractory fibers, aerogel, insulative fire clay, pumice and combinations thereof.

10. A composite fire-resistant and heat absorbing article, comprising:
at least two layers of a fire-retardant and heat-resistant fabric joined together so as to form at least one cavity between the at least two layers; and
a heat-distributing and/or heat reflective material disposed within the at least one cavity.

11. A composite fire-resistant and heat-blocking article as recited in claim 10, wherein the at least two layers of fire-retardant and heat-resistant fabric include fibers having a limiting oxygen index (LOI) of at least 50 such that the at least two layers of fire-retardant and heat-resistant fabric will not support combustion when exposed to a flame or another heat source.

12. A composite fire-resistant and heat-blocking article as recited in claim 11, wherein the fire-retardant and heat-resistant fabric is formed from reinforced oxidized polyacrylonitrile.

13. A composite fire-resistant article as recited in claim 12, wherein at least one layer of the fire-retardant and heat-resistant fabric is a woven material.

14. A composite fire-resistant article as recited in claim 12, wherein at least one layer of the fire-retardant and heat-resistant fabric is a non-woven material.

15. A composite fire-resistant and heat-blocking article as recited in claim 10, wherein the core material is selected from the group consisting of aluminum foil, metalized polyimide film, metalized fire-resistant fabric, and combinations thereof.

16. A composite fire-resistant and heat-blocking article as recited in claim 10, further comprising at least one moldable element included such that the article can be stably molded to fit around a shaped surface.

17. A composite fire-resistant and heat-blocking article as recited in claim 16, wherein the moldable element comprises a flexible metal wire disposed around a periphery of the article.

18. A method of making a composite fire-resistant and heat-blocking article, the method comprising:
providing at least two layers of a fire-retardant and heat-resistant fabric;
providing at least one layer of a heat-diffusing and/or heat-reflective material;
arranging the at least two layers of fabric and the at least one layer of heat-diffusing and/or heat-reflective material such that the fire-retardant and heat-resistant fabric layers form first and second outer layers and the heat-diffusing and/or heat-reflective material is disposed between the first and second outer layers of fabric; and
joining the fabric and metallic or metalized layers together to form the composite fire-resistant and heat-blocking article.

19. A method as recited in claim 18, wherein the at least two layers of fire-resistant fabric include reinforced oxidized polyacrylonitrile.

20. A method as recited in claim 18, wherein the joining includes at least one of sewing, needle punching, gluing, or riveting.

21. A method as recited in claim 18, further comprising:
providing an insulative heat barrier material selected from the group consisting of felted fabrics, woven fabrics, spun refractory fibers, aerogel, insulating fire clay, pumice and combinations thereof, and
placing the insulative heat barrier material among the at least one layer of a heat-diffusing and/or heat-reflective material between the first and second outer layers of the fire-retardant and heat-resistant fabric.
